(19) United States
(12) Patent Application Publication
(10) Pub. No.: US 2005/0065869 A1
(43) Pub. Date: Mar. 24, 2005

(54) Systems, methods, and articles of manufacture for loaning securities

(76) Inventors: Soeren Rabe, Ostringen (DE); Mathias Sonnek, Oberhausen-Rheinhausen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/912,220

(22) Filed: Aug. 6, 2004

(30) Foreign Application Priority Data
Aug. 8, 2003 (EP) 03017592.1
Aug. 8, 2003 (EP) 03017593.9
Aug. 8, 2003 (EP) 03017594.7
Aug. 8, 2003 (EP) 03017595.4

(51) Int. Cl. G06F 17/60

(52) U.S. Cl. 705/37

(57) ABSTRACT

Systems and methods consistent with the present invention may be provided for conducting of an auction for a loan of securities. For example, a request to offer the loan of securities may be posted on a site of a computer network, an offer may be received from an offeror in response to the request, one or more inquiries for the loan of securities may be received from one or more bidders, the offer may be compared with the one or more inquires, and the results of the comparison may be provided to the offeror. The results may include a list of bidders, an indication as to the bidder whose inquiry matches best with the offer, or both.

### RELATED APPLICATIONS

This application claims the benefit of European Patent Application Nos. 03017592.1, 03017593.9, 03017594.7, and 03017595.4, filed Aug. 8, 2003. In addition, this application is related to U.S. patent application Ser. No. ______ [Attorney Docket No. 07781.0190-00], entitled “Systems, Methods, and Articles of Manufacture for Loaning Securities,” filed concurrently herewith. The contents of all the aforesaid applications are expressly hereby incorporated by reference to their entireties.

### BACKGROUND

1. Technical Field

The present invention relates generally to the area of electronic data processing. More particularly, the invention relates to systems, methods, and articles of manufacture for loaning securities using an electronic marketplace.

2. Background Information

Loaning of securities is known in the art. However, the problem in the loaning business is that a company that wants to borrow securities must find a partner who wants to lend the desired securities in a desired quantity and over a desired time period. Vice versa, a company that wants to lend its securities faces the problem of finding a partner who wants to borrow the desired securities in a desired quantity and over a desired time period and for the desired price. This problem is partially solved today by banks, who bring borrowers and lenders together and who in return charge one or both parties a commission.

With respect to general trading of products and services, electronic marketplaces exist, which allow for computerized trading via an online network, such as the Internet. For example, WO 01/69464 A1 discloses an electronic marketplace for continuous computerized trading of products and services described by a given number of product parameters. This document is especially directed towards a method for computerized trading of state products and an automatic trading machine.

As a further example, WO 00/34899 A1 teaches an integrated auction for remote online bidders and live participants at an auction site. The document discloses a method and apparatus for conducting an integrated auction that incorporates various features of traditional and online auctions.

U.S. 2002/0038285 A1 discloses a marketplace that provides a globally accessible exchange that facilitates transactions between educational institutions and lenders, and between loan (credit) sellers and loan buyers. The document discloses a system and a method for the selection of lender for placement on a school's preferred lender list.

Although the documents mentioned above disclose the electronic trading of products, services, and credits, the loaning of securities is neither disclosed nor suggested by these documents.

Thus, there is a need for systems, methods, and articles of manufacture that provide a more efficient solution to the problems of loaning securities described above. In addition, it is desirable to provide a mechanism for enabling the loaning of securities at lower costs.

### SUMMARY

In accordance with an embodiment of the invention, a method is provided for conducting an auction for a loan of securities. The method may include posting a request to offer the loan of securities on a site of a computer network, receiving from an offeror an offer, the offer responding to the request via the site, receiving one or more inquiries for loan of securities from one or more bidders, comparing the offer with the one or more inquires, and providing to the offeror results of the comparison. The results may include a list of bidders, an indication as to the bidder whose inquiry matches best with the offer, or both.

Moreover, consistent with another embodiment, a system is provided for conducting an auction for a loan of a security. The system may include a memory including a program and a processor that runs the program. The program may receive from an offeror an offer to loan a security, solicit from at least one bidder at least one inquiry for a loan of a security, receive from the at least one bidder the at least one inquiry, compare the offer with the at least one inquiry, and provide to the offeror results of the comparison.

Furthermore, consistent with yet another embodiment of the invention, a computer-readable medium is provided that may be adapted to cause a computer or processor to perform a method for conducting an auction for a loan of securities. The method may include posting a request to offer the loan of securities on a site of a computer network, receiving from an offeror an offer, the offer responding to the request via the site, receiving one or more inquiries for loan of securities from one or more bidders, comparing the offer with the one or more inquires, and providing to the offeror results of the comparison.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described herein.

### BRIEF DESCRIPTION OF THE DRAWINGS

The accompanying drawings are incorporated in and constitute a part of this specification and, together with the description, explain the principles of the invention. In the drawings:

FIG. 1 is a schematic view of an exemplary electronic marketplace comprising a trading system and user systems;

FIG. 2a is schematic block diagram of an exemplary trading system and a user system;

FIG. 2b is a schematic block diagram demonstrating, by way of example, the interaction of a user system and the trading system;

FIG. 3 is an exemplary flow diagram demonstrating, by way of example, a process that may be used to loan a security; and

FIGS. 4-7 are schematic examples of web pages that may be used for loaning a security.

### DETAILED DESCRIPTION

The terms used in this specification shall have their usual meaning in the context of the field of data processing unless defined otherwise. As used herein, “the computer provides” and “the program provides or performs specific actions”, “a user performs a specific action” are convenient abbreviation to express actions by a computer system that is controlled by a program or to express that the program or program module is designed to enable the computer system to perform the specific action or the enable a user to perform the specific action by means of a computer system. Moreover, as used herein, the term “presentment” does not include the specialized definition normally associated with commercial paper, i.e., the production on a negotiable instrument to a drawee. Rather, the term refers to providing information via electronic means. This electronic presentment may, for example, take place through the use of a website or via email.

Methods consistent with the present invention may be implemented by a computer system connected to the Internet, thus providing an Internet marketplace. Such computer systems may comprise one or more program modules for performing the method. In addition, the computer system may be a stand-alone computer, such as a PC or a laptop, a series of computers connected as a network, such as a network within a company, or a series of computers connected via the Internet.

Consistent with the present invention, a request for an offer may be posted, for example, on a website. Such a website may include one or more pages, which may provide editable data fields. The editable data fields may be coupled with tables from which predefined values for the respective data field may be selected and entered into the respective data field.

An offeror may enter information about the securities he/she wants to lend and the loan conditions using, for example, the editable data fields on a web page. Such information may include, for example, name and address of offeror, start and end time of the loan, name and ID of the security, ID of the bank depot of the securities, loan fee, and duration of the offer. The offeror can enter such information via a computer system and a web browser.

The offeror may send the entered data to a trading system, for example, by selecting an appropriate link on the web page. The trading system may then solicit inquiries by presenting the offer to others via the website or other means, such as email. Inquiries may also be solicited via other ways, such as advertising and telemarketing.

The trading system may also receive from bidders one or more inquiries for loan of securities via the website. Further, a list of bidders may be presented to the offeror. This step may be implemented by sending a file with the addresses of the bidders via email to the offeror. Alternatively, or additionally, a file with the addresses of the bidders may be made accessible to the offeror via the Internet. In this case, a link to the file may be sent to the offeror via email. The list of bidders may alternatively or additionally be presented on a page of the web site, preferably for access by the respective offeror. The list can have selection functionality, such as check boxes, to enable the offeror to select a bidder for the loan.

The trading system may also select the inquiry that matches best to a received offer and notify the offeror of that selection. This step may be implemented by comparing the loan conditions, such as price, with the inquiries, and selecting the inquiry, the conditions of which, such as price, comes closest to the conditions of offer. Notification may be sent by electronic means, email, SMS, or the like. The selected bidder can be notified as well. The notification may include information about the bidder and loan conditions.

Alternatively, the notification may include a proposal of a loan contract. This can be implemented using a pre-formulated text document for a word processor. The loan conditions may be automatically inserted into respective fields in the document.

In addition, systems and methods consistent with the present invention may automatically generate a set of loan conditions from the offer and the inquiry and provide them to the offeror and the selected bidder. Moreover, if the loan conditions of the offeror and bidder differ, averaged conditions may be calculated automatically.

Systems and methods consistent with the present invention may also enable the offeror and the selected bidder to enter into a loan contract via the site of the computer network. This embodiment may be implemented by presenting the loan conditions to both parties (offeror and bidder), for example, by sending a link to a website to them. Such a website may present loan conditions and may include a link, such as “Ok” button to obtain confirmation from the offeror and the bidder. Each respective party may give its agreement to the conditions by selecting the link. The legal grounds for the binding effect of such method may be provided by general terms and conditions of business, to which both parties may need to agree before they may be allowed to enter an electronic or Internet marketplace.

In case the offeror and the selected bidder agree on a loan contract, systems and methods consistent with the present invention may present an electronic representation of the contract conditions to the offeror and the selected bidder. This may be implemented by sending an electronic contract, such as a text document, in which the loan conditions agreed upon are entered automatically, by mail to both parties so that the contract can be printed and signed. Furthermore, data files that include the loan conditions can be automatically sent to one or both parties for entering data into their respective financial business software.

The securities mentioned in this specification may comprise any type of financial security, such as stocks, bonds and derivatives thereof.

In order to assure legal certainty to the participants of the loan marketplace, general trading conditions, which may define legal rights and obligations between offeror, bidders and an operator of the electronic marketplace, can be presented to offerors and bidders before they can get access to the loan marketplace. If a party does not agree to such conditions, access may be denied. Thus, systems and methods consistent with the present invention may present general trading conditions to offeror and/or bidder.

Processors suitable for the execution of computer programs consistent with the present invention include, by way of example, both general and special purpose microprocessors, and any one or more processors of any kind of digital computer. Generally, a processor may receive instructions and data from a read-only memory or a random access memory or both. The essential elements of a computer include a processor for executing instructions and one or more memory devices for storing instructions and data. Generally, a computer may also include, or be operatively coupled to receive data from or transfer data to, or both, one or more mass storage devices for storing data, such as magnetic, magneto-optical disks, or optical disks. Information carriers suitable for embodying computer program instructions and data include all forms of non-volatile memory, including semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, application-specific integrated circuits (“ASICs”).

To provide for interaction with a user, embodiments consistent with the invention may be implemented on a computer system having a display device such as a cathode ray tube (“CRT”) or liquid crystal display (“LCD”) monitor for displaying information to the user and a keyboard and a pointing device, such as a mouse or a trackball, by which the user can provide input to the computer. Other kinds of devices may be used to provide for interaction with a user as well; for example, feedback provided to the user can be any form of sensory feedback, such as visual feedback, auditory feedback, or haptic feedback; and input from the user can be received in any form, including acoustic, speech, or haptic input.

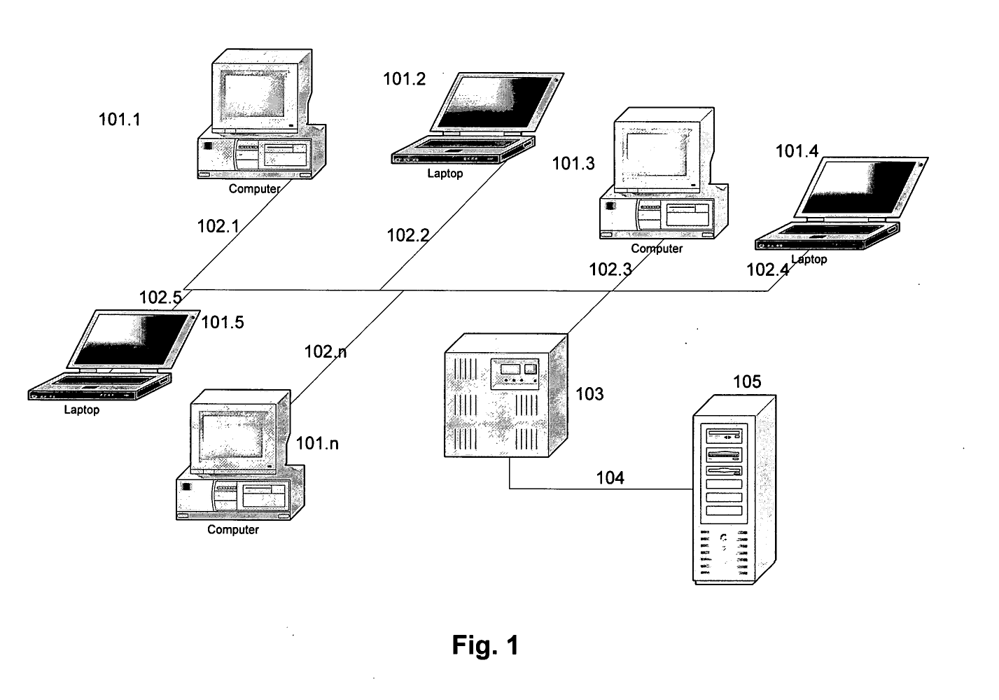

FIG. 1 depicts one example of an implementation of an embodiment of an electronic marketplace. The figure shows an indefinite number of systems 101.1 to 101.n of market participants (users), whereby a system may be assigned to several users and one user may be assigned to several systems. In FIG. 1, the user systems are exemplary and are shown as computer systems, particularly as desktop computers and laptop computers. The user systems 101.1 to 101.n may be connected to a communication system 103 by data communication connections 102.1 to 102.n. The communication system 103 may be a digital communication system, which allows for data transfer in both directions. The communication system 103 may be based on various standards and can be a modem connection, a connection based on communication protocols, such as WAP, TCP/IP, or CORBA, an Internet connection, or a Datex-P connection, a LAN or WAN network, or any combination of these connections.

A trading system 105 may be connected to the communication system 103 by a data communication connection 104. The trading system 105, which enables the virtual electronic marketplace, may be any electronic apparatus. In FIG. 1, the electronic marketplace is shown as a computer 105. Alternatively, the electronic marketplace may be arranged on two or more computer systems as well. The trading system 105 may allow for the simultaneous use of the marketplace by any number of user systems 101.

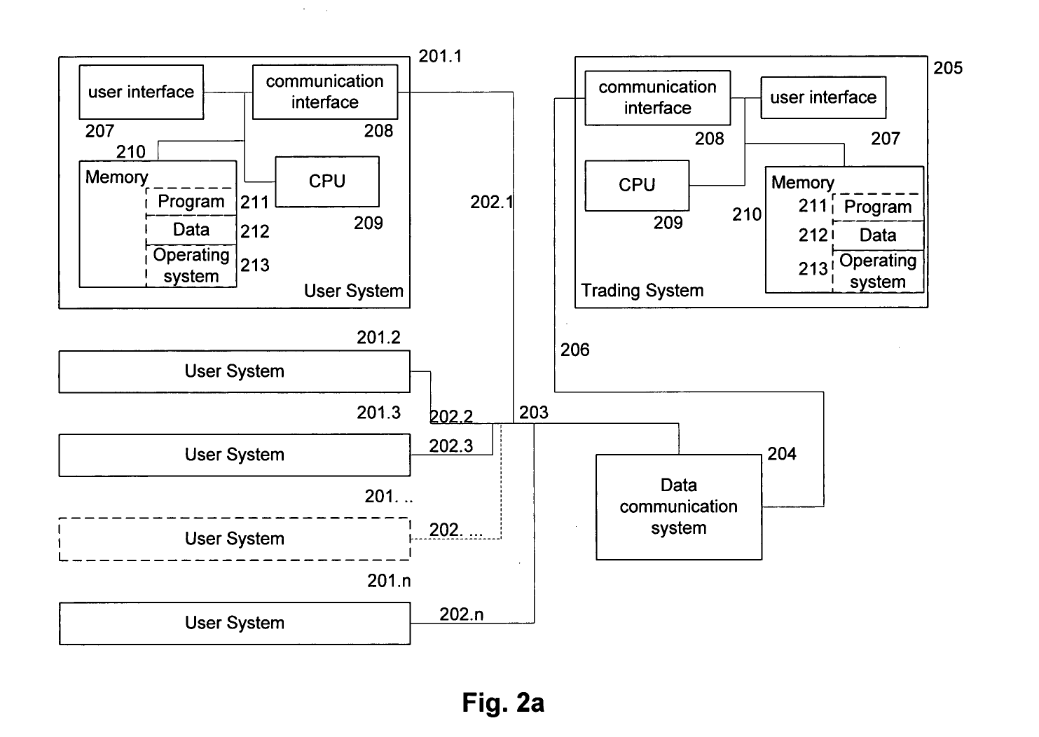

FIG. 2a shows schematically exemplary internal structures of the user system 101 and of the trading system 105 of FIG. 1. A user interface 207 may allow a direct data input into the trading system 205 by a user. This can be useful, for example, for administering trading system 205. The user interface 207 may include, for example, a monitor, a keyboard, a disk drive, and a CD-ROM drive. The trading system 205 may further comprise a digital communication interface 208 by means of which the trading system 205 may exchange data with user systems 201.1 to 201.n, which may be connected to the data communication system 204 via data communication connections 202.1 to 202.n. The trading system 205 may be connected to the data communication system 204 via data communication connection 206. The communication interface 208 may send data to the data communication system 204 and may receive data from the communication system 204.

The trading system 205 further comprises a central processing unit 209, which essentially performs the process of loaning securities via the virtual marketplace. Although only one CPU 209 is shown in FIG. 2a, the process may also be performed by a plurality of CPUs. The CPU 209 executes instructions, which may be stored in a memory 210. The user interface 207, the communication interface 208, CPU 209, and memory 210 may be interconnected by a data bus of the trading system 205.

Memory 210 may comprise a section 213, in which an operating system may be stored. The operating system may control basic operations of the trading system 205, such as data input and output, access to periphery devices, and priority management of processes that run on the CPU. Memory 210 may further comprise a section 211, in which one or more executable programs may be stored. Memory 210 may also include a section 212, in which data for the access of the operating system and/or the executable programs may be stored. Memory 210 may consist in whole or in part of a RAM or a ROM memory. CD-ROMs, hard disk drives, and other such devices may be used as memory as well.

As can be seen in FIG. 2a, a user system 201.1 to 201.n may be structured in the same way as trading system 205.

FIG. 2b shows, by way of example, the interaction of a trading system 214 and a user system 218. A user program 219 may be installed on the user system 218, and a communication module 215 may be installed on the trading system 214. The user program 219 may exchange data with the communication module 214. The user program 219 may be the interface by which a market participant can interact with the trading system 214. The communication module 215 may receive the data from the user systems and send them to one or more further internal processes 216 (marketplace module(s)), for further processing. The trading system 214 may further comprise one or more databases 217 for storage purpose. Such databases may be internal or external (as shown by reference numeral 220). The user program 219 can be, for example, a browser, such as Internet Explorer.

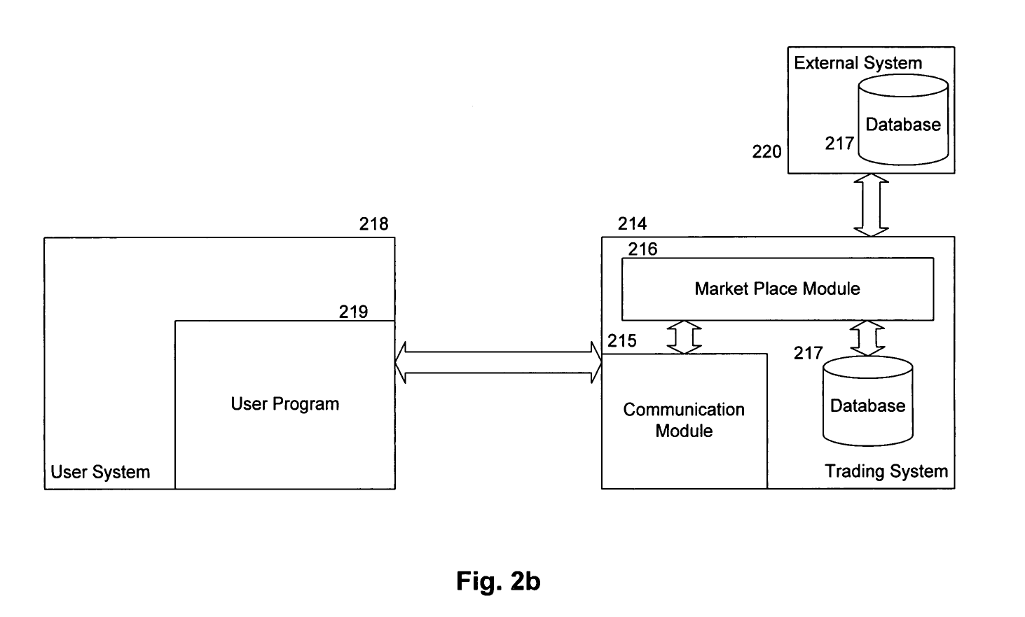

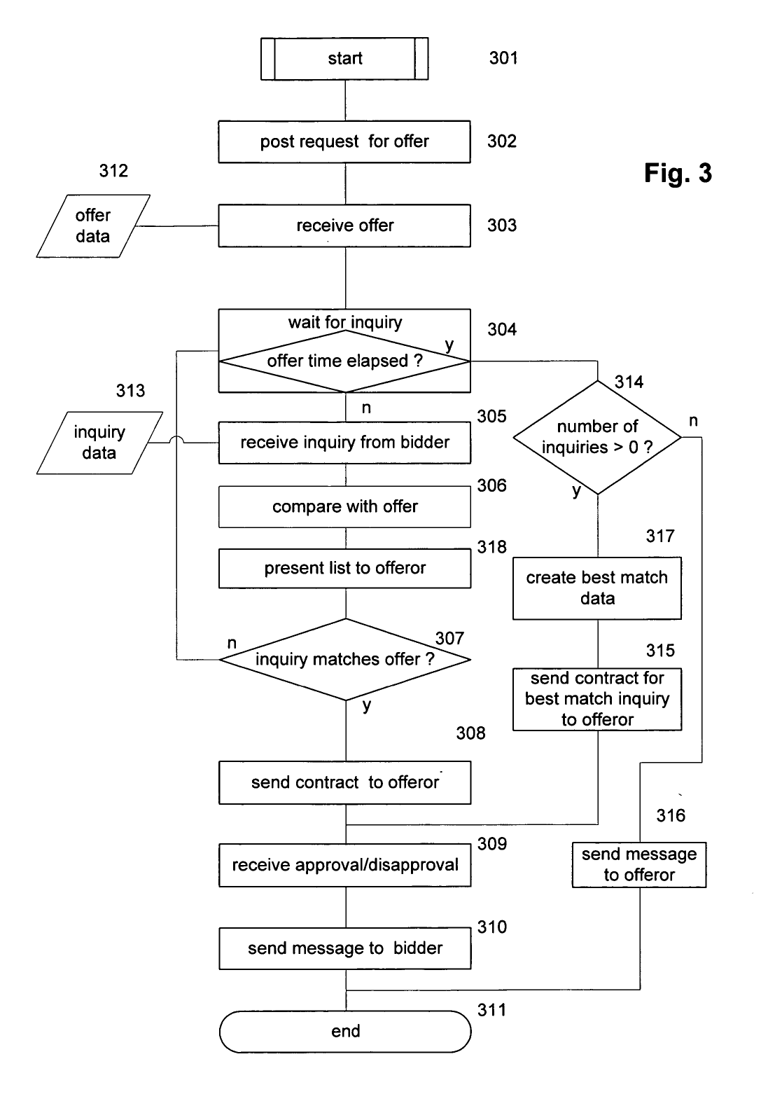

FIG. 3 shows an exemplary flow chart of a process for loaning securities. As illustrated in FIG. 3, the process may be initiated by presenting a request for an offer to potential offerors by, for example, providing a corresponding website (steps 301 and 302). An example of a web page from such a web site is shown in FIG. 4. Specifically, FIG. 4 shows a page 401 comprising a header area 402 in which potential loaners are invited to enter the loan marketplace, i.e., the trading system 205 or 214. The structured documents that may include XML or HTML files and that enable such web pages may be stored in database 217 and can be accessed by the user program 219 of the user system 218 via communication module 215 and marketplace module(s) 216.

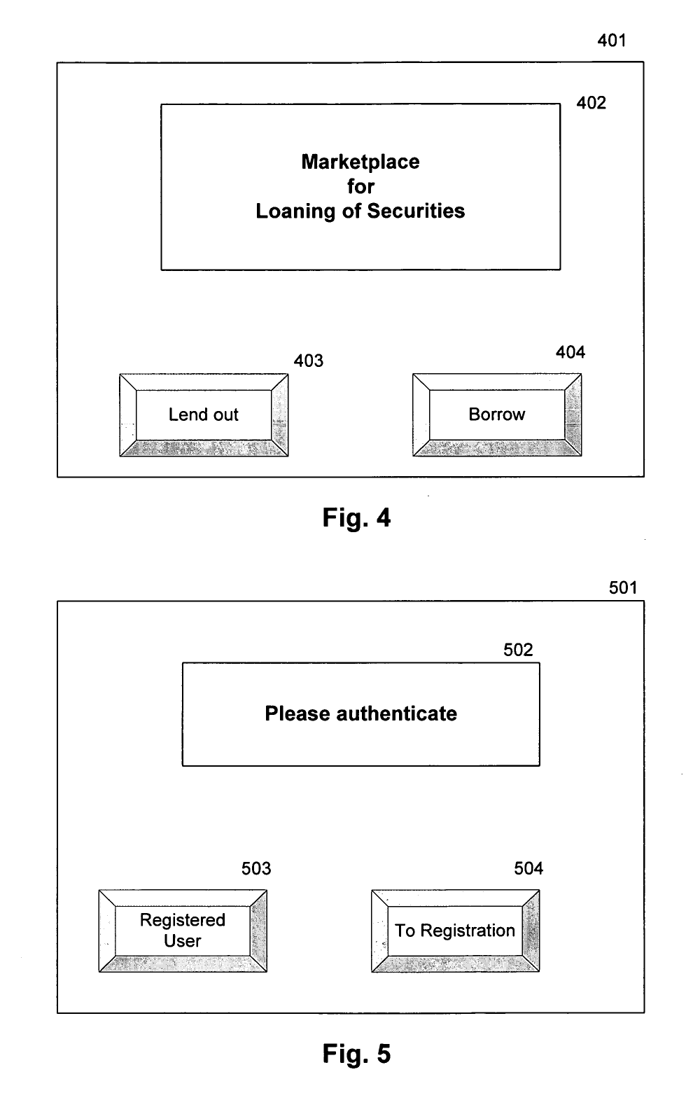

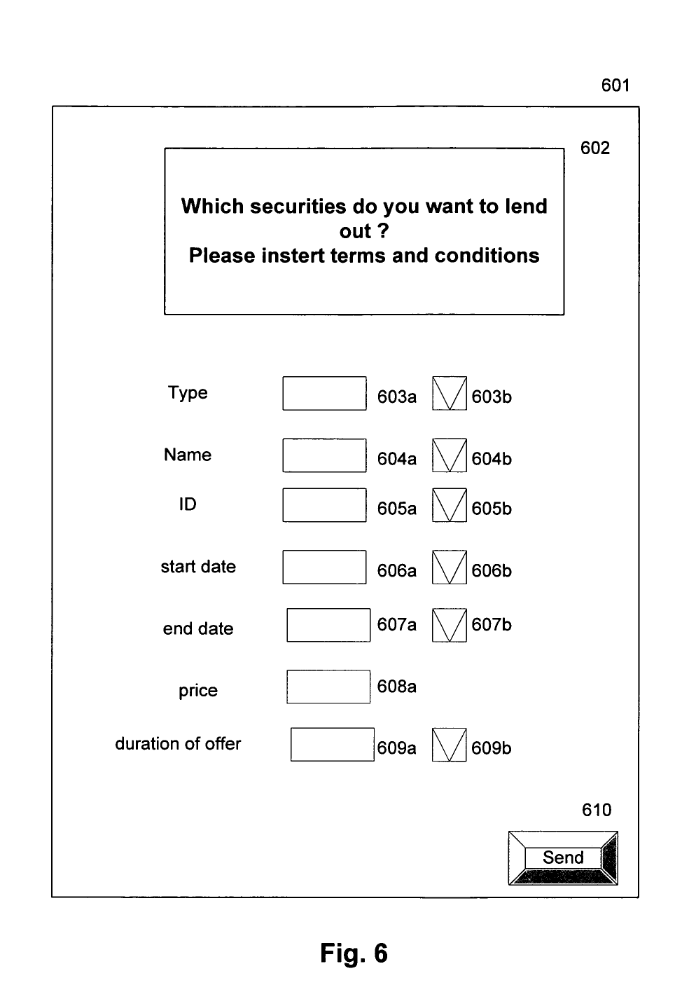

Users who want to lend out their securities can use system 218 to enter the marketplace by using link 403 within their user program 219. Link 404 applies to users who want to borrow securities. Link 403 may lead to a subsequent page 501 that is shown in FIG. 5. Page 501 requires authentication of the interested user indicated in area 502. A link 504 leads to a subsequent authentication page (not shown). Registered users may directly move forward by selecting link 503. Link 503 leads to a subsequent web page 601, such as that shown in FIG. 6.

By means of page 601, the user may enter the terms and conditions according to which he intends to lend out his securities. For that purpose, page 601 provides editable data fields 603a to 609a. Such fields may be connected with tables 603b to 609b, in which allowable values for the respective fields may be stored for selection by the user and for automatic input of the selected value into the respective data field. The fields may be used to gather various kinds of information. For example, in field 603a, the type of the securities to be lent out, such as stocks or bonds or derivatives thereof, may be entered, or selected via table 603b. In field 604a, the name of the security may be entered or selected via table 604b. Alternatively or simultaneously, an ID of the security may be entered in field 605a, or selected via table 605b. Start and end date of the loan period may be defined by means of fields 606a, b and 607a, b, respectively. The price for the loan may be entered in field 608a, and the duration of the offer may be entered in field 609a, b.

Selecting a send button 610 on page 601 may cause the user program 219 to send the data to the communication module 215 of the trading system 214, which may receive the offer data 312 (step 303). The data are then sent to the marketplace module(s) 216 for storage and further processing.

The trading system then waits for an inquiry from a bidder (step 304). For example, the trading system may present the offer to others via the website and wait for inquiries. The trading system may also solicit inquiries by presenting the offer to others via other means, such as email.

If no inquiry data 313 is received until the offer time has elapsed (step 314), a message indicating that no inquiry has been received may be sent to the offeror (step 316) and the process may terminate (step 311).

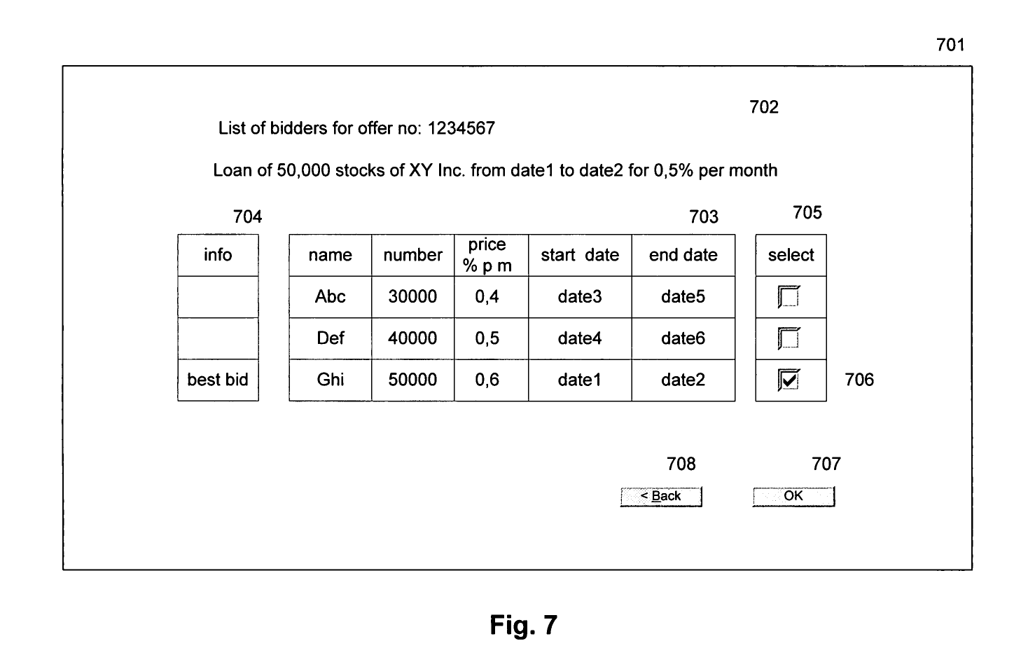

If inquiry data 313 is received from a bidder (step 305), the inquiry data 313 may compared with the offer data (step 306). After that comparison, a list of bidders may be presented to the offeror (step 318). This may be performed by mailing a list to the offeror or, as in the example, by means of a web page 701, shown in FIG. 7, accessible to the offeror. Web page 701 may comprise an area 702, in which textual information on the offer are shown. Page 701 further comprises an area 703, in which a table containing information of the inquiries are shown. The table may comprise a first column with the name of the bidder, a second and third column for the number of the securities and price (rate) the bidder wants to achieve, and a fourth and a fifth column for the desired start and end date, respectively.

Page 701 may further comprise an area 704, in which results of the comparison of the inquiries with the offer are shown. In the example, the comparison revealed that the inquiry of Ghi matches best according to pre-selectable matching conditions, i.e. it is the most advantageous. Page 701 may further comprise an area 705 with radio check boxes 706, by means of which the offeror can select one or more bidders for the loaning business. Each of the businesses then may be conducted at different conditions. In the example, Ghi is the partner of choice. In case the offeror wants to close page 701 without making any decision, he/she can select the “back” button 708. In case the offeror has selected a partner for the loan business, he/she may confirm this selection by selecting an “OK” button 707.

If the inquiry matches the offer, or matches the offer to a pre-selectable degree, or the offeror closes a page 702 using the “OK” button, a loan contract containing the inquiry data is sent to the offeror (step 308).

After receiving an approval or a disapproval from the offeror (step 309), a corresponding message is sent to the bidder (step 310) and the process terminates (step 311). In an alternate embodiment, the securities may be automatically transferred from a deposit account of the offeror to a deposit account of the bidder.

If the result of the comparison of the offer and inquiry data (step 306) reveals no match (step 307), the system returns to the waiting stage (step 304). If, after the offer time has elapsed, none of the inquiries matches the offer, a best match is created automatically (step 317), preferably from the offer data and the inquiry data, which comes closest to the offer data. The best match may, for example, contain mean values of price and start and/or end date. Then, a contract containing such best match values may be sent as a proposal to the offeror (step 315) and the process continues as described above (steps 309-311).

The marketplace module(s) 216 may be configured in such a way that a user (i.e., an offeror or a bidder) can choose what information is sent to his (potential) loaning partner. Further, a web page comprising a list of bidders can be presented to an offeror.

Still further, a fee for using the trading system can be invoiced to bidders and/or offerors by an operator of the trading system.

Other embodiments of the invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or in hardware alone. Additionally, although aspects of the present invention are described for being stored in memory, one skilled in the art will appreciate that these aspects can also be stored on other types of computer-readable media, such as secondary storage devices like hard disks, floppy disks, or CD-ROM; the Internet or other propagation medium; or other forms of RAM or ROM.

Computer programs based on the written description and flow charts of this invention are within the skill of an experienced developer. The various programs or program modules can be created using any of the techniques known to one skilled in the art or can be designed in connection with existing software. For example, programs or program modules can be designed in or by means of Java, C++, HTML, XML, or HTML with included Java applets or in SAP R/3 or ABAP. One or more of such modules may be integrated in existing e-mail or browser software.

It is intended that the specification and examples be considered as exemplary only, with a true scope and spirit of the invention being indicated by the following claims.

1. A method for conducting an auction for a loan of securities, comprising:
posting a request to offer the loan of securities on a site of a computer network;
receiving from an offeror an offer, the offer responding to the request via the site;
receiving one or more inquiries for the loan of securities from one or more bidders;
comparing the offer with the one or more inquires; and
providing to the offeror results of the comparison.

2. The method of claim 1, wherein receiving from an offeror an offer comprises receiving information about the offer, the information including at least one of a name of the offeror, a duration of the offer, information about the securities, and a loan fee.

3. The method of claim 1, wherein providing to the offeror results of the comparison comprises providing to the offeror a list of bidders.

4. The method of claim 3, wherein providing to the offeror results of the comparison further comprises providing information about the one or more inquiries.

5. The method of claim 4, wherein the information includes an indication as to the inquiry that matches best with the offer.

6. The method of claim 1, wherein providing to the offeror results of the comparison comprises selecting from the one or more inquiries the inquiry that matches best with the offer and notifying the offeror of that selection.

7. A method for conducting an auction for a loan of a security using an online network, comprising:
receiving from an offeror an offer to loan a security;
soliciting from at least one bidder, on a site of the online network, at least one inquiry for a loan of a security;
receiving from the at least one bidder the at least one inquiry;
comparing the offer with the at least one inquiry; and
providing to the offeror results of the comparison.

8. The method of claim 7, wherein receiving from a offeror an offer to loan a security comprises receiving information about the offer, the information including at least one of a name of the offeror, a duration of the offer, information about the security, and a loan fee.

9. The method of claim 7, wherein soliciting from at least one bidder at least one inquiry comprises soliciting the at least one inquiry for a time period specified in the offer.

10. The method of claim 7, wherein providing to the offeror results of the comparison comprises providing to the offeror information about the at least one bidder.

11. The method of claim 10, wherein the information includes details about the at least one inquiry.

12. The method of claim 10, wherein the information includes an indication as to the at least one inquiry that matches best with the offer.

13. The method of claim 7, wherein providing to the offeror results of the comparison comprises selecting the at least one inquiry that matches best with the offer and notifying the offeror of that selection.

14. The method of claim 7, wherein providing to the offeror results of the comparison comprises providing to the offeror a list of bidders.

15. A system for conducting an auction for a loan of a security, comprising:
a memory including a program that:
receives from an offeror an offer to loan a security,
solicits from at least one bidder at least one inquiry for a loan of a security,
receives from the at least one bidder the at least one inquiry,
compares the offer with the at least one inquiry, and
provides to the offeror results of the comparison; and
a processor that runs the program.

16. The system of claim 15, wherein the results include a list of bidders.

17. The system of claim 15, wherein the results include an indication as to the at least one inquiry that matches best with the offer.

18. A computer-readable medium containing instructions for causing a computer to perform a method for conducting an auction for a loan of securities, the method comprising:
posting a request to offer the loan of securities on a site of a computer network;
receiving from an offeror an offer, the offer responding to the request via the site;
receiving one or more inquiries for the loan of securities from one or more bidders;
comparing the offer with the one or more inquires; and
providing to the offeror results of the comparison.

19. The computer-readable medium of claim 19, wherein providing to the offeror results of the comparison comprises providing to the offeror a list of bidders.

20. The computer-readable medium of claim 19, wherein providing to the offeror results of the comparison comprises selecting from the one or more inquiries the inquiry that matches best with the offer and notifying the offeror of that selection.
